(19) United States
(12) Patent Application Publication
(10) Pub. No.: US 2022/0260107 A1
(43) Pub. Date: Aug. 18, 2022

(54) CONNECTION UNIT AND METHOD FOR PRODUCING A CONNECTION UNIT

(71) Applicant: Schneider + Stahl Besitzunternehmen GbR, Schöntal (DE)

(72) Inventors: Ewald Schneider, Forchtenberg (DE); Simon Stahl, Heilbronn (DE); Ronald Meisel, Rosenberg-Sindolsheim (DE)

(21) Appl. No.: 17/623,099

(22) PCT Filed: Jun. 23, 2020
(86) PCT No.: PCT/EP2020/067476

§ 371 Date: Dec. 27, 2021

(30) Foreign Application Priority Data
Jun. 28, 2019 (DE) 10 2019 209 510.0

(51) Int. Cl. F16B 43/00

(52) U.S. Cl. CPC F16B 43/001; F16B 43/003

(57) ABSTRACT

A method for producing a connection unit (1) which has a connector with a connector shaft (6) and a disc (3) which is captively arranged on the connector shaft (6). The disc (3) has an annular disc body (23), the inner contour (33) and outer contour (34) of which have been produced by a plastic deformation of the disc body (23). The inner contour (33) is shaped such that the disc body (23) is fixed on the connector shaft (6). At the same time, the originally non-circular outer contour (34) is shaped so as to be at least substantially circular. The deformation process is carried out by introducing radial deformation forces into the outer circumferential surface (27) of the disc body (23).

The invention relates to a method for producing a connection unit, wherein the connection unit comprises a connector, said connector being with a connector shank which comprises a connection structure and with a connector head which is arranged on the connector shank and projects radially beyond the connector shank, and wherein the connection unit further comprises an annular disc which comprises a plastically deformable annular disc body and a through-hole which is framed by the annular disc body and through which the connector shank passes, wherein the annular disc body has an outer peripheral surface which defines an outer contour of the disc body and an inner peripheral surface which peripherally delimits the through-hole and defines an inner contour of the disc body, wherein for the captive fixation of the disc which is seated on the connector shank, the inner contour of the disc body in the state of the disc in which it is seated on the connector shank and starting from a preliminary inner contour which permits the prior sticking of the disc onto the connector shank is reshaped by way of plastic reshaping of the disc body into a final inner contour which effects a captive fixed holding of the disc on the connector shank and which differs from the preliminary inner contour.

The invention further relates to a connection unit with a connector which comprises a connector shank and a connector head, said connector shank being provided with a connection structure and said connector head being arranged on the connector shank, wherein the connector head projects radially beyond the connector shank, and with an annular disc which comprises an annular disc body, said disc body consisting of a plastically deformable material and framing a through-hole through which the connector shank passes and which is peripherally delimited by an inner peripheral surface of the disc body, said inner peripheral surface defining an inner contour of the disc body which is produced by plastic material reshaping of the disc body, wherein this inner contour is designed such that the disc is captively held on the connector shank by way of interaction with the connector shank, and wherein the annular disc body has an outer peripheral surface which defines an outer contour of the disc body.

A connection unit of the aforementioned type which is denoted as a fastener unit and which can be manufactured by a method designed in the aforementioned context is known from DE 10 2014 118 342 A1. The known connection unit has a connector with a connector shank and a connector head, wherein a captively fixed annular disc is put onto the connector shank which is provided with an outer thread. The disc functions as a washer and/or as a sealing disc. The captive securing of the disc results from an annular disc body of the disc being plastically deformed in a radially inwardly directed manner in the region of its inner peripheral surface in the state in which it is seated on the connector shank, in a manner such that the through-hole is reduced in size. A radial overlapping of the disc body with a ring projection of the connector shank results from this size reduction, so that the disc is captured between the connector head and the ring projection and can no longer fall down from the connector shank.

According to the internal knowledge of the applicant which is not documented in writing, a captive securing of a disc on a screw shank can also be effected by way of an annular disc body being used, said disc body being contoured in a circularly round manner radially at the outside as well as radially at the inside before being put onto the screw shank and in the state in which it is put onto the screw shank being pressed together from two diametrically opposite sides such that an oval or elliptical ring contour sets in radially at the inside as well as radially at the outside. Given unfavourable dimensional conditions, this however on designated use of the screw unit can lead to the screw head no longer lying completely on the disc body, which becomes more of a problem if a sealing is to be effected by the disc.

It is known from U.S. Pat. No. 5,056,208 A to radially deform a holding ring which at its inner periphery comprises inwardly projecting rectangular tongues and at its outer periphery outwardly projecting projections or recesses, by way of pliers, in a manner such that the tongues engage into longitudinal grooves of the shank of a screw, so that the holding ring can no longer be removed from the shank.

According to DE 42 24 310 A1, a securing element is deformed into an annular groove of a shank by way of radial deformation, in order to fix a nut. The securing element at the outside has three radially projection tabs, which on deformation can be used for force introduction.

It is the object of the present invention to provide measures, by way of which a disc can be captively fixed on a connector shank in an inexpressive and process-reliable manner and in a manner such that a secure lying of the connector head on the disc can be ensured given a subsequent designated use of the connection unit.

For achieving this object, given a method for producing a screw unit of the initially mentioned type, one envisages
the annular disc body before its plastic reshaping being provided with a preliminary outer contour which differs from a circular shape, and being put onto the connector shank,
and the plastic reshaping of the annular disc body which creates the final inner contour of the annular disc body being carried out by way of radial deformation forces being introduced into the outer peripheral surface which has the preliminary outer contour, of the disc body which is seated on the connector shank;
wherein the plastic reshaping of the annular disc body is designed such that the final inner contour of the annular disc body differs from a circular shape and simultaneously a final outer contour of the disc body which differs from the preliminary outer contour and which is at least essentially circular is also shaped.

Concerning the method according to the invention, the disc which is to be captively secured has an annular disc body which before sticking onto the connector shank and thus before its plastic reshaping has a preliminary outer contour which is designed in a non-circular manner. Given the subsequent plastic reshaping of the annular disc body, not only does the inner contour of the disc body undergo a change in shape, but also the outer contour of the disc body. Hence the preliminary inner contour and the preliminary outer contour of the annular disc body which are present before the plastic reshaping are reshaped by way of the reshaping procedure into a final inner contour and into a final outer contour which differ from the respectively prior preliminary contouring. The deformation forces which are necessary for the reshaping are introduced with a radial orientation into the outer peripheral surface of the disc body which still has the preliminary outer contour, in the state of the disc body being seated on the connector shank. The plastic reshaping of the annular disc body is effected in a manner such that a non-circular final inner contour sets in. On account of this non-circular final inner contour, such a captive securing results due to the interaction of the disc with the connector shank that the disc can no longer fall down from the connection shank. The final inner contour can herein in particular be shaped such that the disc body at least partially immerses into a premanufactured annular-groove-like deepening of the connector shank and/or is pressed with the outer peripheral surface of the connector shank, so that a press fit is present. The plastic reshaping of the annular disc body is further designed such that an at least essentially circular final outer contour of the disc body results. On plastic reshaping, the firstly non-circular outer contour is therefore pressed into an at least essentially circularly round shape. By way of this, one can ensure a particularly uniform axial contact between the connector head and the disc body given the subsequent designated use of the screw unit. Such a reshaping also has advantages from an aesthetic viewpoint, since the outer contour of the disc adapts itself to the outer contour of the connector head all around in a uniform manner.

The manufacturing method can be carried out in a simple and inexpensive manner and in a very process-reliable manner even with high production numbers by way of suitably adapted forming tools. The reshaping can be carried out in a targeted manner such that despite the final inner contour which differs from the circular shape, a reliable annular lying of the screw head on the disc body is ensured given designated use of the screw unit. The manufacturing method can be applied independently of a certain shaping of the connector shank, since the reshaping procedure can be carried out without any problem in a manner specific to the connector shank.

Given designated use of the produced connection unit, the disc for example functions as a washer and/or as a sealing disc. The captive fixation of the disc on the connector shank permits a uniform handling of the two components as a subassembly grouped into the connection unit, on storage, transport and use. An awkward joining-together of the connector and disc into the connection unit by the user directly before designated use is done away with. Furthermore one can ensure that the connection unit always has a functionally compliant combination of connector and disc.

Advantageous further developments of the method according to the invention are defined in the dependent claims.

The plastic reshaping of the annular disc body in particular is designed such that a final inner contour of the peripheral surface sets in, concerning which surface sections of the inner peripheral surface whose radial distance to the centre of the disc is differently large successively alternate in the circumferential direction of the through-hole.

It is seen as being favourable if the annular disc body is plastically reshaped in a manner such that after the formation of the final inner contour, the inner peripheral surface has concavely curved and convexly curved surface sections which successively alternate in the circumferential direction of the through-hole. It is then in particular the regions of the annular disc body which have the convexly curved surface sections which mechanically interact with the connector shank for the captive securing. The convexly contoured surface sections expediently project radially inwards towards the centre of the disc with respect to the concavely curved surface sections.

It is likewise considered as being advantageous if the plastic reshaping is carried out such that the final inner contour of the disc body is concavely curved throughout, wherein surface sections of the inner peripheral surface with a differently large curvature alternate in the circumferential direction of the through-hole. Such a final inner contour is designed for example in an ovally or elliptically arcuate manner.

The disc body which is to be fixed is provided with a preliminary inner contour before being put onto the connector shank, said inner contour providing the through-hole with an adequately large cross-sectional surface, in order to permit a problem-free sticking onto the connector shank. The sticking of the annular disc body onto the connector shank which entails the connector shank passing through the through-hole can be very simply accomplished if the preliminary inner contour of the disc body is a round inner contour, wherein this round inner contour is preferably at least circularly round.

Concerning the preliminary outer contour which of the annular disc body which differs from the circular shape, it is expediently a preliminary outer contour which is convexly curved all around in the circumferential direction of the through-hole, concerning which surface sections of a differently large curvature alternate in the circumferential direction of the through-hole.

For example, the annular disc body before its plastic reshaping has a polygonal preliminary outer contour which is convexly rounded all around in the circumferential direction of the through-hole and hence also at the corner regions. Herein, expediently the convex curvature in the corner regions is greater than in the regions of the disc body which lie between the corner regions. The polygonal contour is preferably a uniform rounded polygon contour.

It has been found to be particularly advantageous to provide the annular disc body with a trilobular preliminary outer contour before its plastic reshaping and to stick it onto the connector shank. The trilobular contour manifests itself in a triangular basic shape of the outer contour which however is indeed rounded throughout, wherein the diameter of the annular outer contour is equally large at each location of the outer periphery. It is merely positional differences which are present at the diameter centres. Outer contour sections with a large and small radius of curvature lie diametrically opposite one another in pairs.

Another preliminary outer contour which is very well suited for the method according to the invention is shaped ovally or elliptically.

Given the plastic reshaping of the annular disc body, expediently the regions of the preliminary outer contour which are designed in a radially raised manner are deformed radially in the direction of the disc centre, wherein the deformation results in the metallic material at the inner periphery of the disc displacing in the direction of the disc centre. In combination with a circularly round preliminary inner contour and a reshaping to the extent that the final outer contour is circularly round, the deformation behaviour of the disc body in particular is manifested in the non-circular preliminary outer contour being conferred upon a correspondingly shaped final inner contour.

Concerning a method procedure which is seen as being particularly advantageous, the annular disc body before its plastic reshaping is provided with such a preliminary outer contour and preliminary inner contour that it has ring segments with a radial thickness which differs from one another which alternate successively in the circumferential direction of the through-hole, so that ring segments of a minimal radial thickness alternate with ring segments of a maximal radial thickness in the circumferential direction of the through-hole. Given the plastic reshaping, the radial deformation forces are introduced such that the disc body after the plastic reshaping continues to have ring segments of a minimal radial thickness and ring segments of a maximal radial thickness which successively alternate in the circumferential direction of the through-hole, wherein however the surface sections of the inner peripheral surface and of the outer peripheral surface of the annular disc body, said surface sections being formed on the ring segments of maximal radial thickness, have a smaller distance to the centre of the disc after the plastic reshaping than before the plastic reshaping. Concerning the ring segments of a minimal radial thickness, the distance of the surface sections which belong to the inner peripheral surface to the centre of the disc is preferably equally large or larger after the reshaping than before the reshaping.

Even if the connector shank in the region in which the disc is located has an outer diameter which is larger than or equally large as the length section of the connector shank which connects towards the free shank end, the disc can be captively fixed in a reliable manner when the annular disc body given its plastic deformation is pressed radial upon the connector shank in a manner such that it is clamped to the connector shank at its inner peripheral surface with a radial press fit.

A press fit fastening of the disc body when necessary can also be carried if the disc is seated on the connector shank in the region of an annular-groove-like deepening. The disc body is then pressed with the base surface of the annular deepening.

For the fixation on the connector shank, the disc body can also be reshaped in a manner such that it is fixed on the connector shank in a loose manner without a radial press fit. This being in cases in which the connector and in particular the connector shank at its outer periphery is structured such that the reshaped disc body is axially supported, for example by way of the disc body being radially deformed into an annular-groove-like deepening of the connector shank.

The annular-groove-like deepening which can be manufactured for example as a recess in a material-removing manner can be placed at an arbitrary location along the connector shank.

With regard to an expedient embodiment of the method, the connector shank before sticking on the disc which is to be captively fixed is provided with an annular-groove-like deepening which at the side of the free end of the connector shank is delimited by a front deepening flank which faces the connector head. Before the plastic reshaping of the disc body, the disc is put onto the connector shank such that it comes to lie axially at the height of the annular-groove-like deepening. The plastic reshaping of the disc body which is subsequent to this is effected in a manner such that the inner peripheral surface of the disc body immerses at least partially into the annular-groove-like deepening and a radial overlapping between the disc body and the front deepening flank of the annular-groove-like deepening sets in.

Given an embodiment as a screw shank, the connector shank is preferably provided with a shaping to the extent that the front deepening flank is axially directly adjacent to an outer threaded section of the screw shank. Differing from this, the annular-groove-like deepening however can also be formed at an axial distance to a possibly present outer threaded section.

The annular-groove-like deepening can so be realised or become realised by way of the connector shank comprising a radially projecting ring coil at an axial distance to the connector head.

The disc body of the disc is expediently manufactured as a punched part for forming the preliminary inner contour and the preliminary outer contour. Alternatively, the disc body can also be manufactured for example by a casting method or by way of a material-removing machining, for example by way of milling.

With regard to the material which is used on the production of the disc body, this is for example metal such as steel or a copper material. Basically however, any ductile material which is suitable for a plastic deformation can be used for the disc body, thus for example also a plastic material or a composite material.

The connection unit is preferably manufactured as a screw unit, wherein the connector is designed as a screw and the connector shank is provided with a connection structure which is designed as an outer thread.

The connector can be realised for example as a bayonet connector which on its connector shank comprises a connection structure which is designed a bayonet connection structure. Alternatively to the example, the connector can also be designed as a plug-in connector which comprises a spring-elastic structure on the connector shank. A likewise possible embodiment of the connector is that of a screw connector, concerning which the connector shank is a threaded rod and the connector head at least one nut which is screwed onto the threaded rod.

Particularly preferably, the connection unit is designed a screw unit, concerning which the connector is a screw which as a connector shank comprises a screw shank. The screw shank has a connection structure which is designed as an outer thread. A screw head as a connector head is arranged on the screw shank in a fixed manner and in particular as one piece.

The object on which the invention is based is also achieved by a connection unit which supplementarily to the initially mentioned features is characterised in
that the annular disc body is designed as a reshaping part, wherein the inner contour is based on a radial plastic reshaping of the disc body, said disc body being provided in a holed form and said reshaping having been created by the introduction of a radial deformation force into the radial outer peripheral surface of the disc body,
that the outer contour of the annular disc body is designed at least essentially circularly,
and that the inner contour of the annular disc body is designed in a non-circular manner.

In this manner, the connection unit comprises a disc which is captively seated on the connector shank and whose disc body has a circular outer contour and a non-circular inner contour. Concerning this outer contour and inner contour, these are final contours which result from a radial plastic reshaping of the annular disc body, said disc body being designed as a reshaping part which before the plastic reshaping has an only preliminary inner contour and outer contour. On designated use of the screw unit, a reliable annular axial lying of the connecter head on the disc body can be ensured by way of the circular outer contour, so that tightening forces can be uniformly transmitted. Furthermore, in this manner a reliable sealing can be ensured if the disc functions as a sealing disc. On account of the non-circular inner contour, the annular disc body is fixedly held on the connector shank in a captive manner.

Preferably, the inner peripheral surface which defines the inner contour of the annular disc body is shaped such that it has surface sections of a differently large radial distance to the centre of the disc which successively alternate in the circumferential direction of the through-hole.

It is further advantageous if the inner contour of the annular disc body is concavely curved throughout, wherein surface sections of the inner peripheral surface of a differently large curvature alternate in the circumferential direction of the through-hole.

The inner contour of the annular disk body is preferably designed in an oval or elliptical manner. An alternative design envisages the inner peripheral surface comprising concavely curved and convexly curved surface sections which successively alternate in the circumferential direction of the through-hole.

It is seen as being favourable if the outer contour and the inner contour of the annular disc body are shaped in a manner such that the annular disc body comprises ring segments with a radial thickness which differs from one another in a successively alternating manner in the circumferential direction of the through-hole, so that ring segments of a minimal radial thickness alternate with ring segments of a maximal radial thickness in the circumferential direction of the through-hole, wherein the surface sections of the inner peripheral surface which are formed on the ring segments of a maximal radial thickness have a lower radial distance to the centre of the disc than the surface sections of the inner peripheral surface which are formed on the ring segments of a minimal radial thickness.

Preferably, the connection unit is a screw unit whose connector is a screw, wherein the connector shank is a screw shank which comprises an outer thread as a connection structure.

Inasmuch as the connector which is used for carrying out the manufacturing method or for realising the connection unit is a screw, this screw preferably comprises a screw head which is expediently provided with an inner profiling and/or with an outer profiling, in order to form a tool engagement section, on which a screwing tool can be applied given designated use of the connection unit. The inner profiling and/or outer profiling are designed for example as a polygon and in particular as a hexagon.

Inasmuch as one speaks of a contour being shaped at least essentially circularly, in particular this means that a circular shape is preferably present, but however slight deviations from the circular shape can also be present on account of manufacturing tolerances or manufacturing measures.

A convexly curved surface in the context of the invention in particular is to be understood as a surface which is arched in a manner projecting towards the viewer, in particular in a manner such that a middle surface region projects with respect to surface regions which are adjacent on both sides with respect to this. A concavely curved surface in the context of the invention in particular is to be understood as a surface which is arched in a deepened manner away from the viewer, in particular in a manner such that a middle surface region is set back with respect to surface regions which are adjacent on both sides with respect to this.

The invention is herein explained in more detail by way of the accompanying drawings. In these are shown in:

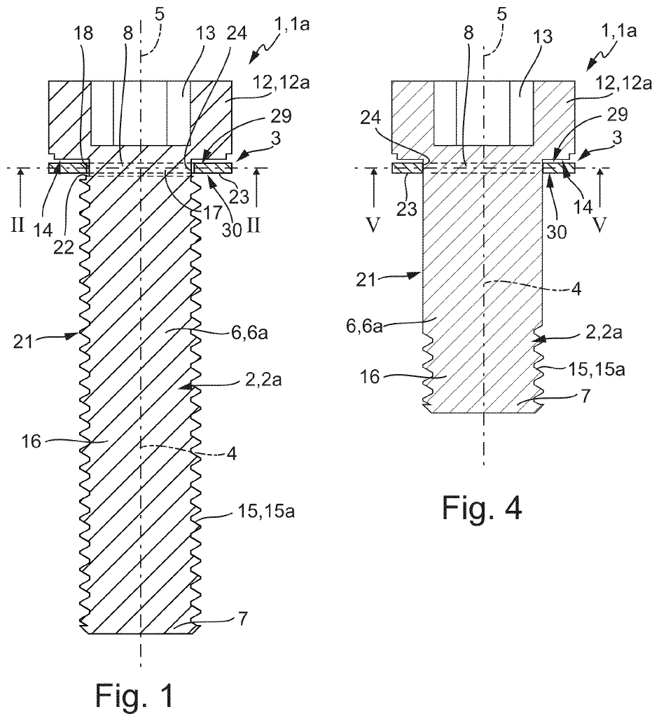

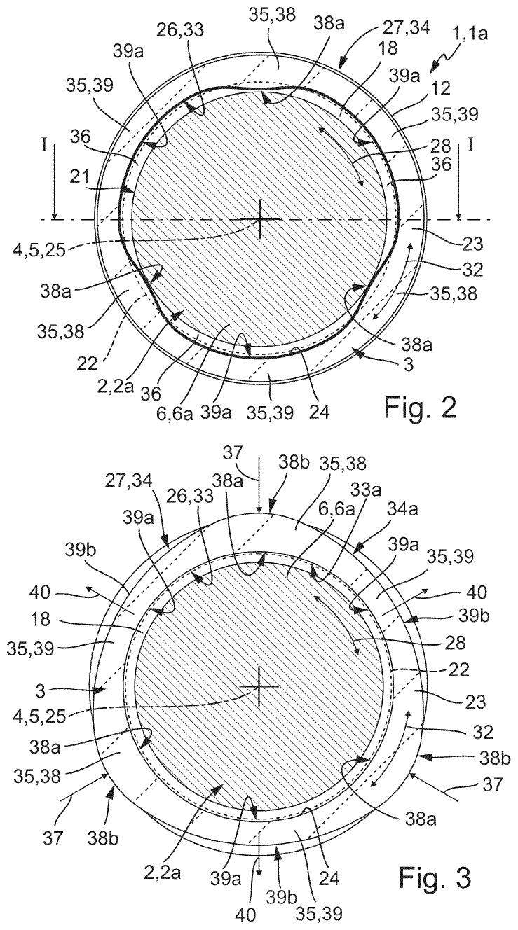

FIG. 1 a preferred embodiment of the connection unit according to the invention in a preferred embodiment as a screw unit in a longitudinal section according to section line I-I of FIG. 2, wherein the connection unit is produced by way of the method according to the invention,

FIG. 2 a cross section of the connection unit of FIG. 1 according to section line II-II in FIG. 1,

FIG. 3 a cross section of the connection unit of FIGS. 1 and 2 according to section line II-II of FIG. 1, in the state of the disc body although being put onto the connector shank, not yet plastically reshaped,

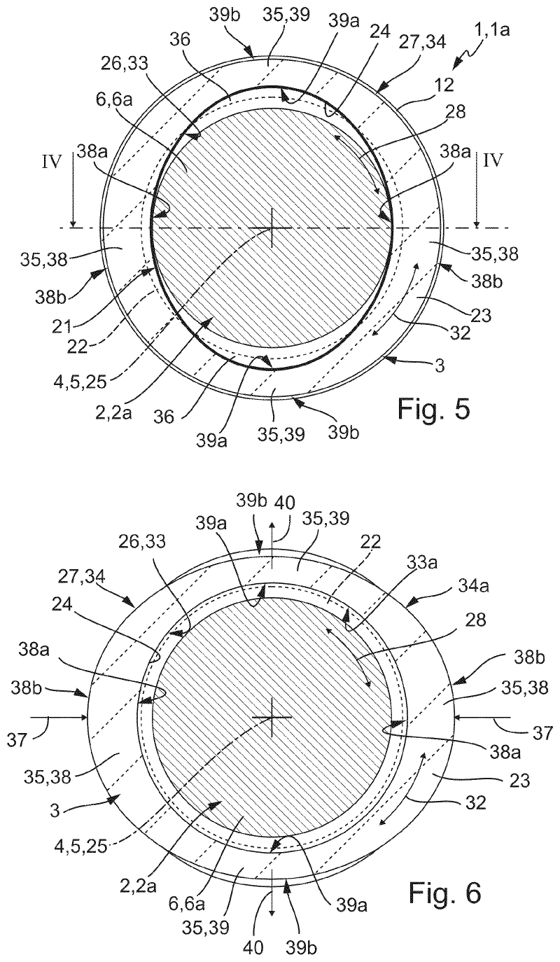

FIG. 4 a further embodiment example of a connection unit according to the invention in a longitudinal section according to section line V-V of FIG. 5,

FIG. 5 a cross section of the connection unit of FIG. 4 according to section line IV-IV in FIG. 4, and

FIG. 6 a cross section of the connection unit of FIGS. 4 and 5 according to the section line V-V of FIG. 4 in the state of the disc body although being put on the connector shank, not yet plastically reshaped.

The connection unit which is denoted in its entirety with the reference numeral 1 and is illustrated in the drawings in its different embodiments, comprises a connector 2 and an annularly structured disc 3 which is grouped together with the connector 2 into a subassembly which can be handled as a unit.

On account of a particular shaping which was caused by preceding plastic material reshaping measures, the disc 3 is unified with the connector 2 in a captive manner whilst forming the connection unit 1. The connector 2 has a longitudinal extension with a longitudinal axis 4. The disc 3 has a longitudinal axis 5 and is expediently seated at least essentially coaxially on the connector 2. The disc 3 has a centre 25 which lies on the longitudinal axis 5.

The connector 2 which preferably consists of metal comprises a connector shank 6 which extends coaxially to the longitudinal axis 4 and is with a free front end region 7 and a rear end region 8. A connector head 12 of the connector 2 connects coaxially onto the rear end region 8. The connector 2 can also consist of a non-metallic material.

Concerning the illustrated embodiment examples, the connector head 12 terminates the connector 2 at the rear side. However, a constructional form concerning which the connector 2 comprises two connector shanks 6 and the connector head 12 is arranged axially between the two connector shanks 6 is also possible.

The connector head 12 is preferably attached to the connector shank 6 in a fixed manner and in particular as one piece. However, a design concerning which these are parts which are separate from one another is also possible.

The connector shank 6 in the region of its outer periphery with provided with a connection structure 15, via which the connector 2 is connectable to a counter-piece which is not shown, in particular whilst forming a positive connection. In this manner, the connection unit 1 can be used for example to fasten two arbitrary components or parts to one another.

The outer diameter of the connector head 12 is larger than the outer diameter of the connector shank 6 at least at its rear end region 8. The connector head 12 therefore projects radially beyond the connector shank 6 all around. The connector shank 6 preferably has a smaller outer diameter 12 than the connector head 12 over its entire length. The connector head 12 however can also be arranged or formed asymmetrically on the connector shank 6 in a manner such that it does not radially project beyond this at the periphery all around, but only partially which is to say at only one or more locations, for example in the manner of a hook.

The connector 2 is preferably designed as a screw 2a, so that the connection unit 1 is a screw unit 1a. This is the case with the illustrated embodiment examples. Hereby, the connector head 12 is formed by a screw head 12a which is connected to the connector shank 6 as one piece, and with regard to the connector shank 6 this is a screw shank 6a which as a connection structure 15a comprises an outer thread 15a.

Concerning an embodiment example which is not illustrated, the connector 2 is a bayonet connector with a connection structure 15 which is arranged on the connector shank 6 and which is designed as a bayonet connection structure and consists for example of one or more radial projections. Concerning an embodiment example which is likewise not illustrated, the connector 2 is a plug-in connector with a radially spring-elastic connection structure 15. Likewise not illustrated is a possible design of the connector 2 as a screw connector, concerning which the connector shank 6 is a threaded rod and the connector head 12 at least one nut which is screwed onto the threaded rod.

Preferred measures according to the inventions are explained hereinafter by way of connection units 1 which are designed as screw units 1a, wherein the explanations which are made with respect to these however accordingly apply to other constructions shapes of connection units 1.

By way of example, a connector head 12 which is designed as a screw head 12a, of a connector 2 which is designed as a screw 2a, has a round and in particular circularly round outer contour radially at the outside. By way of example it is designed in a circularly cylindrical manner. At its rear side which is axially away from the connector shank 6 which its designed as a screw shank 6a, the connector head 12 optionally has a tool engagement section 13 which is formed by an axial deepening of the connector head 12 which is contoured in a non-circular and in particular polygonal manner. A screwing tool can be applied on this tool engagement section 13, in order to rotate the connector 2 about its longitudinal axis 4 for screwing into a complementary inner thread given its designated use.

Concerning an embodiment example which is not illustrated, the tool engagement section 13 is located on the outer surface of the screw head 12a. This is then preferably contoured in a polygonal and in particular rectangular or hexagonal manner at its radial outer periphery.

The connector head 12 does not necessary have a tool engagement section 13. As to whether a tool engagement section 13 is present or how such a tool engagement section 13 is possibly designed depends on the case of application.

The connector head 12 for example can also be designed in a ball-like manner.

The connector head 12 at the face side which faces the connector shank 6 has a front end-face 14 which in particular is extends in a plane which is at right angles to the longitudinal axis 4, and is expediently designed in an annular manner, so that it quasi frames the connector shank 6.

The connector shank 6 which is designed as a screw shank 6a and beyond which the connector head 12 radially projects, as already mentioned has an outer thread 15a as a connection structure 15. The thread type is arbitrary. For example it is a metric thread. The longitudinal section of the connector shank 6 which comprises the outer thread 15a is denoted as an outer threaded section 16.

Concerning the illustrated embodiment examples, the connector shank 6 has a threadless shank section 17 which extends axially between the outer threaded section 16 and the connector head 12. This threadless shank section 17 according to FIG. 1 can be relatively short, but can also have a relatively large axial length according to FIG. 4. For example, the threadless shank section 17 according to the embodiment example of FIG. 1 has a smaller outer diameter than the outer thread section 16. By way of this, an annular-groove-like deepening 18 which is coaxial to the longitudinal axis 4 results, said deepening being axially delimited at the rear side by the front end-face 14 of the connector head 12 and lying axially opposite being demitted by an annular front deepening flank 22 which by way of example terminates the outer threaded section 16 at the rear side.

The annular-groove-like deepening 18 can be incorporated into the connector shank 6 for example in a material removing manner as a recess. However, it can also be rolled in or be shaped in a direct manner give a casting/moulding manufacture of the connector 2. The annular-groove-like deepening 18 can basically be formed in the connector shank 6 at any arbitrary axial position and at any arbitrary axial length.

The connector shank 6 can also be designed for example in the shape which is evident from FIG. 4, wherein the outer diameter of the threadless shank section 17 corresponds to the outer diameter of the outer threaded section 16. Here, no further annular surface then lies opposite the front end-face 14 of the connector head 12 analogously to the front deepening flank 22 of the embodiment example of FIG. 1.

With regard to the screw 2 of FIG. 4, the outer thread 15 is expediently incorporated into the screw shank 6 in a material-removing manner. In contrast to this, concerning the embodiment example of FIG. 1 the outer thread 15 is preferably a rolled thread which is produced by a material reshaping or a pressed thread. The manufacturing manner of the outer thread 15 in principle can be selected in an arbitrary manner.

The disc 3 which is seated on the connector shank 6 is expediently located on the threadless shank section 17 according to the two embodiment examples.

If the outer thread 15 extends directly up to the connector head 12 and no threadless shank section is present between the outer thread 15 and the connector head 12, then the disc 3 is expedient seated directly on the outer thread 15.

In particular, the disc 3 functions as a washer and/or a sealing disc. It is used as a washer for example if a fastening measure is carried out by way of the connector 2, in order for example to screw two components or parts to one another or to connect them to one another in another manner. The disc 3 functions as a sealing disc for example in cases in which the screw 2a is used as a plug screw for example as an oil drainage plug in the case of a machine or vehicle.

The disc 3 has an annular disc body 23 which frames an axially continuous through-hole 3 of the disc 3. The disc body 23 consist of a material which has ductile characteristics, so that it can be plastically reshaped in a permanent manner when applying deformation forces. It preferably consists of metal but can however also consist of plastic. The disc body 23 can be a multi-component body without further ado.

Depending on the application purpose of the disc 3, the disc body 23 consists for example of steel or of a copper material. In particular in the context of a sealing function, the disc body 23 of the disc 3 can be additionally combined with another material, in particular with plastic and hereby in particular with an elastomer material.

The annular disc body 23 which is hereinafter merely denoted as a disc body 23 for simplification has an inner peripheral surface 26 which is annularly closed per se and faces the centre 25 of the disc 3. The inner peripheral surface 26 forms the radially peripheral delimitation of the through-hole 24. The disc body 23 furthermore has an outer peripheral surface 27 which faces radially away from the centre 26 and is annularly closed per se. The inner peripheral surface 26 defines an inner contour 33 of the disc body 23. The outer peripheral surface 27 defines an outer contour 34 of the disc body 27.

The disc body 23 further has two annular end-faces 29, 30 which are axially opposite one another. A rear end-face 29 of these end-faces 29, 30 faces the connector head 12. Each end-face 29, 30 extends between the inner peripheral surface 26 and the outer peripheral surface 27. Both end-faces 29, 30 expediently extend in plane which is at right angles to the longitudinal axis 5. However they can also be inclined conically.

The through-hole 24 has a circumferential direction 28 which is indicated by a double arrow. The circumferential direction 28 runs all round the centre 25 or around the longitudinal axis 5. The disc body 23 has a circumferential direction 32 which also runs around the centre 25 which is to say the longitudinal axis 5.

On account of an inner contour 33 of the disc body 23 which differs from a circular shape and which is described in more detail hereinafter, the disc 3 which is seated on the connector shank 6 is axially captively held on the connector shank 6 by way of the interaction of the disc body 23 with the connector shank 6. The disc 3 therefore cannot fall down from the connector shank 6 irrespective of possible movements or shaking of the screw 2. The screw unit 1 which can only be handled as a unit results from this.

The annular disc body 23 is a reshaping part and has obtained its inner contour 33 and outer contour 34 as final contours by way of the disc body 23 having undergone a targeted plastic reshaping. FIGS. 3 and 6 show the disc body 23 before the plastic reshaping, wherein one can also denote the disc body 23 which is present in this non-deformed shape as a disc body blank.

Concerning the screw unit 1 which is manufactured according to the invention, the inner contour 33 represents an final inner contour 33 and the outer contour 34 a final outer contour 34 of the disc body 23. Before the plastic reshaping, the disc body 23 or the disc body blank has an only preliminary inner contour 33a and only a preliminary outer contour 34a. The shape change of the disc body 23 which is caused in a targeted manner on reshaping leads to the preliminary inner counter 33 being reshaped into the final inner contour 33 which is shaped differently from this and simultaneously to the preliminary outer contour 34a being reshaped into the final outer contour 34 which is shaped differently from this.

Before the plastic reshaping, the disc body 23 is provided in a holed form with the preliminary inner contour 33 and the preliminary outer contour 34a. The disc body 23 which is still undeformed is expediently manufactured as a punched part. Alternatively, the disc body 23 can be manufactured for example also by way of casting or injection moulding or by way of a material-removing machining, for example by way of milling.

The reshaping procedure takes place in the state of the disc or disc body 23 in which it is plugged on the connector shank 6. The disc body 23 is hereby positioned on the connector shank 6 where it is also to be located after the reshaping procedure.

The preliminary inner contour 33a is designed such that the through-hole 24 has an adequately large cross-sectional area, in order to permit an unhindered sticking-through of the connector shank 6.

The plastic reshaping of the disc body 23 is carried out by way of deformation forces 37 which are oriented radially with respect to the centre being introduced into the disc body 23 into the outer peripheral surface 27 which has the preliminary outer contour 34a. This is illustrated schematically by arrows in FIGS. 3 and 6. The deformation forces 37 are preferably generated by machine.

The preliminary outer contour 34a differs from a circular shape. The undeformed outer peripheral surface 27 in other words is therefore contoured in a non-circular manner. Given the plastic reshaping of the disc body 23, the ring contour of the outer peripheral surface 27 as well as the ring contour of the inner peripheral surface 26 is permanently changed.

Common to all illustrated embodiment examples is the fact that the plastic reshaping of the disc body 23 is designed such that the final outer contour 34 which results from this at least essentially and expediently has an exact circular shape. An optimal symmetry with respect to the connector head 12 results from this and accordingly a uniform introduction of axial pressing forces when the screw 2 is fastened given designated use of the connection unit 1.

Basically, the final outer contour 33 can also be an arbitrary other final outer contour 34 which differs from the preliminary outer contour 33.

The plastically reshaped disc body 23 preferably has such a final inner contour 33 that the inner peripheral surface 26 has surface sections of a differently large radial distance to the centre of the disc 25 which successively alternate in the circumferential direction 28 of the through-hole 24. This applies to both illustrated embodiment examples.

The disc body 23 can be imaginarily subdivided into several ring segments 35 which materially merge into one another in a direct manner and are successive in its circumferential direction 32. A physical separation between these ring segments 35 is not present. However, there are preferably two types of ring segments 35 which are contoured differently from one another and which for an improved differentiation are denoted as main ring segments 28 and as transition ring segments 39. The inner peripheral surface 26 is composed of surface sections which are formed on the main ring segments 39 and of surface sections which are formed on the transition ring segments 39 and which for a better differentiation are denoted as main inner surface sections 38a and as transition inner surface sections 39a. An alternating sequence of main inner surface sections 38a and transition inner surface sections 39a is present in the circumferential direction, these each merging into one another in a direct manner and preferably without a step.

Concerning the embodiment example of FIGS. 1 and 2, the disc body 23 has three main ring segments 38 and three transition ring segments 39, wherein the disc body 23 according the embodiment example of FIGS. 4 and 5 each only has two main ring segments 38 and transition ring segments 39. Whereas the latter lie diametrically opposite one another in pairs, with the embodiment example of FIGS. 1 and 2 an angular offset within the main ring segments 38 and the transition ring segments 39 of about 120 degrees results.

The main inner surface sections 38a have a smaller distance to the centre 25 than the transition inner surface sections 39a.

According to the embodiment example of FIGS. 1 and 2, the reshaped disc body 23 can have a final inner contour 33 which is shaped in a manner such that concavely and convexly curved arched surface sections of the inner peripheral surface alternate in the circumferential direction 32. With regard to the illustrated preferred embodiment example, the main inner surface sections 38a are bulged out convexly in the direction of the centre 25, whereas the transition inner surface sections 39a have a convex arch shape.

Differing from this, the final inner contour 33 in particular can also be shaped or become shaped such that it is concavely curved throughout in the circumferential direction 32, wherein however surface sections of a differently large curvature alternate. Such a design is implemented with the embodiment example of FIGS. 4 and 5 and specifically in a manner such that the final inner contour 33 is shaped ovally or elliptically. By way of example, the two transition inner surface sections 39 have a greater curvature than the main inner surface sections 38a.

Common to the illustrated embodiment examples is the fact that the final outer contour 34 and the final inner contour 33 of the annular disc body 23 are shaped such that ring segments 35 with a radial thickness which differs from one another successively alternate in the circumferential direction 28, 32. The radial thickness is measured in the direction which is radial with respect to the longitudinal axis 5. By way of example, the maximal radial thickness at the main ring segments 38 is larger than at the transition ring segments 39. Preferably, a flowing transition between the ring segments 35, 38, 39 which have a different maximal radial thickness results in the circumferential direction 32.

Common to both illustrated embodiment examples of the manufacturing method is the fact that the disc body 23 has a round preliminary inner contour 33a before its plastic reshaping, wherein preferably according to FIGS. 3 and 6 it is an at least essentially and in particular exact circular preliminary inner contour 33a.

This round and preferably circular preliminary inner contour 33a is expediently combined with a preliminary outer contour 34a which is convexly curved all around in the circumferential direction 32 of the disc body 23, wherein surface sections of a differently large curvature of the outer peripheral surface 27 alternate in the circumferential direction 28, 32.

Concerning the embodiment example of FIGS. 1 to 3, the preliminary outer contour 34a is designed in a polygonal manner, but nevertheless is however convexly rounded all around. For example, a triangular basic shape of the preliminary outer contour 34a is provided. Hereby, particularly advantageous is a so-called trilobular contouring which is illustrated in FIG. 3.

Concerning the embodiment example of FIGS. 4 to 6, the disc body 23 is provided with an oval or elliptical preliminary outer contour 34a for carrying out the reshaping procedure.

Concerning both embodiment examples, the respectively described preliminary outer contour 34a is preferably combined with a circularly round preliminary inner contour 33a.

The disc body 23 preferably has the subdivision into main ring segments 38 and transition ring segments 39 already before the plastic reshaping, thus also already as a disc body blank, said main ring segments and transition ring segments being arranged successively and merging into one another as one piece and said subdivision being described further above by way of the reshaped disc body 23. These main ring segments 38 and transition ring segments 39 however differ in the contouring from those of the plastically reshaped disc body 23.

Concerning the embodiment example of FIG. 3, the corner regions of the polygonal preliminary outer contour 34a are formed by the surface sections of the outer peripherally surface 27 which are formed on the main ring segments 38 and which for an improved differentiation are denoted as main outer surface sections 38b. Surface sections of the outer peripheral surface 27 which are denoted as transition outer surface sections 39b are located on the transition ring segments 39 which connect the main ring segments 38 to one another in pairs.

Concerning the embodiment example of FIGS. 4 to 6, the outer peripheral surface 27 is likewise subdivided into main outer surface sections 38b which are formed on the main ring segments 38 and into transition outer surface sections 39b which are formed on the transition ring segments 39.

As with the reshaped disc body 23, concerning the not yet reshaped disc body 23, the main ring segments 38 expediently also have a larger maximal radial thickness than the transition ring segments 39.

The deformation forces 37 are expediently introduced at all main ring segments 38 into the main outer surface sections 38b which are formed thereon, in a manner directed towards the centre, as is indicated in FIGS. 3 and 6. This has the effect that after the reshaping, the alternating sequence of the main ring segments 38 and the transition ring segments 39 continues to be given, wherein now however the main inner surface sections 38a and the main outer surface sections 38b have a smaller distance to the centre 25 of the disc 3 than before the plastic reshaping.

On reshaping, the main ring segments 38 are pressed radially inwards. The transition ring segments 39 herein retain their radial relative position to the connector shank 6 or are at least slightly deformed radially outwards according to the arrows 40. After the reshaping, the radial distance between the transition inner surface sections 39a and the outer peripheral surface 21 of the connector shank 6 in particular can be constant or larger compared to the state before the reshaping.

Suitable forming tools are applied for the plastic reshaping. For example, a hydraulic or manually actuated collet or a reshaping tube body which comprises a conically tapering tube channel, through which the connector 2 with the disc 3 which is seated thereon is axially pressed, are suitable.

As already mentioned, the plastic material reshaping of the disc body 23 is effected in the state in which the disc body is mounted on the connector shank 6.

For producing a screw unit 1 according to FIGS. 1 to 3, the disc body 23 which forms the disc body blank is placed at the axial height of the ring-groove-like deepening 18 of the connector shank 6 before its radial deformation, so that the radial deformation results in the disc body 23 with the main ring segments 38 being radially pressed into the ring-groove-like deepening 18.

The deformation of the ductile material of the disc body 23 can go so far that the main inner surface sections 38a bear on the radial outer peripheral surface 21 of the connector shank 6 amid clamping within the ring-groove-like deepening 18 and the disc body 23 is consequently held with a press-fit, which is to say captively in a non-positively manner. However, even with a somewhat lower deformation which creates no press fit, nevertheless however an immersing in the main ring segments 38 into the annular-groove-like deepening 18 results in a captive securing of the disc body 23, since the latter cannot overcome the front deepening flank 22. The disc 3 is then seated loosely on the connector shank 6, but despite this in a captive manner.

For producing a connection unit 1 according to FIGS. 4 to 6, the disc body 23 which is present as a disc body blank is radially deformed by the radial deformation forces 37 to such an extent, that it is fixed with the main ring elements 38 onto the connector shank 6 with a press fit. An additional axially positive fixation is not needed here.

Intermediate spaces 36 which are present in the region of the disc 3 between the radial outer peripheral surface 21 of the connector shank 6 and the inner peripheral surface 26 of the disc body 23 are evident in FIGS. 2 and 5. In particular, they are located radially between the transition ring segments 38 and the connector shank 6. It can be easily recognised that the maximal width of these intermediate spaces 36 which is measured radially with respect to the longitudinal axis 4 of the screw 2 is significantly lower than the corresponding measured radial width of the annular front end-face 14 of the connector head 12. Herewith, it is ensured that the connector head 12 bears with its front end-face 14 on the disc body 23 all around given designated use of the screw unit 1, so that a complete lying-on in combination with a reliable sealing effect is ensured.

1. A method for producing a connection unit, wherein the connection unit comprises a connector, said connector being with a connector shank which comprises a connection structure and with a connector head which is arranged on the connector shank and projects radially beyond the connector shank, and wherein the connection unit further comprises an annular disc which comprises a plastically deformable annular disc body and a through-hole which is framed by the annular disc body and through which the connector shank passes, wherein the annular disc body has an outer peripheral surface which defines an outer contour of the disc body and an inner peripheral surface which peripherally delimits the through-hole and defines an inner contour of the disc body, wherein for the captive fixation of the disc which is seated on the connector shank, the inner contour of the disc body in the state of the disc in which it is seated on the connector shank and starting from a preliminary inner contour which permits the prior sticking of the disc onto the connector shank is reshaped by way of plastic reshaping of the disc body into a final inner contour which effects a captive fixed holding of the disc on the connector shank and which differs from the preliminary inner contour, and wherein
wherein the annular disc body, before its plastic reshaping, is provided with a preliminary outer contour which differs from a circular shape, and is put onto the connector shank,
and wherein the plastic reshaping of the annular disc body which creates the final inner contour of the annular disc body is carried out by way of radial deformation forces being introduced into the outer peripheral surface which has the preliminary outer contour, of the disc body which is seated on the connector shank,
wherein the plastic reshaping of the annular disc body is designed such that the final inner contour of the annular disc body differs from a circular shape and simultaneously a final outer contour of the disc body which differs from the preliminary outer contour and which is at least essentially circular is also shaped.

2. The method according to claim 1, wherein the plastic reshaping of the annular disc body is designed such that the inner peripheral surface which defines the final inner contour comprises surface sections of a differently large radial distance to the centre of the disc which successively alternate in the circumferential direction of the through-hole.

3. The method according to claim 1, wherein the plastic reshaping of the annular disc body is designed such that the inner peripheral surface which defines the final inner contour comprises concavely curved and convexly curved surface sections which successively alternate in the circumferential direction of the through-hole.

4. The method according to claim 1, wherein the plastic reshaping of the annular disc body is designed such that the final inner contour is concavely curved throughout, wherein surface sections of the inner peripheral surface of a differently large curvature alternate in the circumferential direction of the through-hole.

5. The method according to claim 1, wherein the annular disc body before its plastic deformation is provided with a round preliminary inner contour and put onto the connector shank.

6. The method according to claim 1, wherein the annular disc body before its plastic reshaping, is provided with a preliminary outer contour which is convexly curved all around, wherein surface sections of the outer peripheral surface which are of a differently large curvature alternate in the circumferential direction of the through-hole.

7. The method according to claim 1, wherein the annular disc body before its plastic reshaping is provided with a polygonal preliminary outer contour.

8. The method according to claim 1, wherein the annular disc body before its plastic reshaping, is provided with a trilobular preliminary outer contour and put onto the connector shank.

9. The method according to claim 1, wherein the annular disc body before its plastic reshaping, is provided with an oval or elliptical preliminary outer contour and put onto the connector shank.

10. The method according to claim 1, wherein the annular disc body, before its plastic reshaping, is provided with such a preliminary outer contour and preliminary inner contour that it has ring segments with a radial thickness which differs from one another which alternate successively in the circumferential direction of the through-hole, so that ring segments of a minimal radial thickness alternate with ring segments of a maximal radial thickness in the circumferential direction of the through-hole, wherein the plastic reshaping of the annular disc body is carried out such that the disc body after the plastic reshaping continues to have ring segments of a minimal radial thickness and ring segments of a maximal radial thickness which successively alternate in the circumferential direction of the through-hole, wherein the surface sections of the inner peripheral surface and of the outer peripheral surface, said surface sections being formed on the ring segments of maximal radial thickness, have a smaller distance to the centre of the disc after the plastic reshaping than before the plastic reshaping.

11. The method according to claim 1, wherein the annular disc body, given its plastic reshaping, is pressed radially onto the connector shank in a manner such that it is fixed at its inner peripheral surface on the connector shank with a radial press fit.

12. The method according to claim 1, wherein before mounting the disc, which is to be captively fixed, the connector shank is provided with an annular-groove-like deepening which is delimited by a front deepening flank which faces the connector head, wherein before the plastic reshaping of the disc body, the disc is put onto the connector shank such that it comes to lie axially at the height of the annular-groove-like deepening, wherein the subsequent plastic reshaping of the disc body is effected in a manner such that the inner peripheral surface of the disc body immerses at least partially into the annular-groove-like deepening.

13. The method according to claim 1, wherein the disc body of the disc with its preliminary inner contour and its preliminary outer contour is produced as a punched part.

14. The method according to claim 1, wherein the connection unit is produced as a screw unit, wherein the connector is designed as a screw and the connector shank is provided with a connection structure which is designed as an outer thread.

15. A connection unit, with a connector which comprises a connector shank which is provided with a connection structure and a connector head which is arranged on the connector shank, wherein the connector head projects radially beyond the connector shank, and with an annular disc which comprises an annular disc body which consists of a plastically deformable material and which frames a through-hole through which the connector shank passes, said through-hole being peripherally delimited by an inner peripheral surface of the disc body which defines an inner contour of the disc body which is produced by the plastic material reshaping of the disc body, wherein this inner contour is designed such that the disc, by way of interaction with the connector shank, is captively held on the connector shank, and wherein the annular disc body has an outer peripheral surface which defines an outer contour-O of the disc body, and
wherein the annular disc body is designed as a reshaping part, wherein the inner contour is based on a radial plastic reshaping of the disc body, said disc body being provided in a holed form and said reshaping having been created by the introduction of radial deformation forces into the outer peripheral surface of the disc body, and
wherein the outer contour of the annular disc body is designed at least essentially circularly, and
wherein the inner contour of the annular disc body is designed in a non-circular manner.

16. The connection unit according to claim 15, wherein the inner peripheral surface of the annular disc body which defines the inner contour comprises surface sections of a differently large radial distance to the centre of the disc which successively alternate in the circumferential direction of the through-hole.

17. The connection unit according to claim 15, wherein the inner contour of the annular disc body is concavely curved throughout in the circumferential direction of the through-hole, wherein surface sections of the inner peripheral surface of a differently large curvature alternate in the circumferential direction of the through-hole.

18. The connection unit according to claim 15, wherein the inner contour of the annular disk body is designed in an oval or elliptical manner.

19. The connection unit according to claim 15, wherein the inner peripheral surface of the annular disc body which defines the inner contour comprises concavely curved and convexly curved surface sections which successively alternate in the circumferential direction of the through-hole.

20. The connection unit according to claim 15, wherein the outer contour and the inner contour of the annular disc body are shaped in a manner such that the annular disc body comprises ring segments with a radial thickness which differs from one another in a successively alternating manner in the circumferential direction of the through-hole, so that ring segments of a minimal radial thickness alternate with ring segments of a maximal radial thickness in the circumferential direction of the through-hole, wherein the surface sections of the inner peripheral surface which are formed on the ring segments of a maximal radial thickness have a lower radial distance to the centre of the disc than the surface sections of the inner peripheral surface which are formed on ring segments of a minimal radial thickness.

21. The connection unit according to claim 15, wherein the connection unit is a screw unit whose connector is a screw, wherein the connector shank is a screw shank which comprises an outer thread as a connection structure.

22. The method according to claim 5, wherein the preliminary inner contour is designed in an at least essentially circular manner.

23. The method according to claim 7, wherein the polygonal preliminary outer contour is convexly rounded all around.
